(19) United States
(12) Patent Application Publication
(10) Pub. No.: US 2026/0330594 A1
(43) Pub. Date: Oct. 22, 2026

(54) IMAGE RENDERING METHOD AND APPARATUS, DEVICE, AND STORAGE MEDIUM

(71) Applicant: Beijing Zitiao Network Technology Co., Ltd., Beijing (CN)

(72) Inventor: Ligang LI, Beijing (CN)

(21) Appl. No.: 19/542,613

(22) Filed: Feb. 17, 2026

(30) Foreign Application Priority Data
Feb. 18, 2025 (CN) 202510180061.9

(51) Int. Cl. G06T 3/4038; G06T 3/4007; G06T 7/70

(52) U.S. Cl. CPC G06T 3/4038; G06T 3/4007; G06T 7/70

(57) ABSTRACT

An image rendering method and apparatus, a device, and a storage medium are provided. The method includes: determining a gaze region of an image frame in an original video stream; rendering the gaze region of the image frame by using a first frame rate to obtain a first video stream; rendering the image frame by using a second frame rate to obtain a second video stream, where the first frame rate is k times the second frame rate, and k is greater than or equal to 2; and obtaining a rendering result of the original video stream according to the first video stream and the second video stream.

### CROSS-REFERENCE TO RELATED APPLICATION

The present application claims priority to Chinese Patent Application No. 202510180061.9, filed on Feb. 18, 2025, which is incorporated herein by reference in its entirety as a part of the present application.

### TECHNICAL FIELD

Embodiments of the present disclosure relate to the field of extended reality technologies, and in particular, to an image rendering method and apparatus, a device, and a storage medium.

### BACKGROUND

With the development of extended reality (Extended Reality, XR) technologies, applications of XR devices have become increasingly widespread, so that a wide variety of XR image contents may be provided to users through the XR devices, thereby providing the users with rich and immersive experience.

Since XR images may include complex scenes, abundant details and elements, as well as realistic visual effects, the complexity of XR images is relatively high. Accordingly, when XR images with relatively high complexity are rendered, more rendering resources are required, resulting in relatively high rendering power consumption for XR images. This tends to cause stuttering in the display of XR images, and also shortens the standby time of XR devices.

### SUMMARY

The embodiments of the present disclosure provide an image rendering method and apparatus, a device, and a storage medium, which may reduce the rendering power consumption for XR images, improve the display smoothness of XR images, and extend the standby time of XR devices.

In a first aspect, an embodiment of the present disclosure provides an image rendering method, including:
determining a gaze region of an image frame in an original video stream;
rendering the gaze region of the image frame by using a first frame rate to obtain a first video stream;
rendering the image frame by using a second frame rate to obtain a second video stream, where the first frame rate is k times the second frame rate, and k is greater than or equal to 2; and
obtaining a rendering result of the original video stream according to the first video stream and the second video stream.

In a second aspect, an embodiment of the present disclosure provides an image rendering apparatus, including:
a region determination module, configured to determine a gaze region of an image frame in an original video stream;
a rendering module, configured to render the gaze region of the image frame by using a first frame rate to obtain a first video stream, and render the image frame by using a second frame rate to obtain a second video stream, where the first frame rate is k times the second frame rate, and k is greater than or equal to 2; and
an output module, configured to obtain a rendering result of the original video stream according to the first video stream and the second video stream.

In a third aspect, an embodiment of the present disclosure provides an electronic device, including:
at least one processor and a memory, where the memory is configured to store a computer program, and the at least one processor is configured to invoke and run the computer program stored in the memory to perform the image rendering method according to the embodiment in the first aspect and various implementations thereof.

In a fourth aspect, an embodiment of the present disclosure provides a non-transient computer-readable storage medium for storing a computer program, where the computer program is configured to cause a computer to perform the image rendering method according to the embodiment in the first aspect and various implementations thereof.

In a fifth aspect, an embodiment of the present disclosure provides a computer program product including program instructions, where the program instructions, when running on an electronic device, cause the electronic device to perform the image rendering method according to the embodiment in the first aspect and various implementations thereof.

### BRIEF DESCRIPTION OF DRAWINGS

In order to more clearly illustrate the technical solutions in the embodiments of the present disclosure, the drawings required to be used in the description of the embodiments will be briefly introduced below. Obviously, the drawings in the following description are only some embodiments of the present disclosure, and for those of ordinary skill in the art, other drawings may also be obtained according to these drawings without paying any creative efforts.

FIG. 1 is a flowchart of an image rendering method provided by an embodiment of the present disclosure;

FIG. 2 is a schematic diagram of a full-view region provided by an embodiment of the present disclosure;

FIG. 3 is a flowchart of obtaining a rendering result for an original video stream provided by an embodiment of the present disclosure;

FIG. 4 is a schematic diagram of obtaining a rendering result of an original video stream according to a first video stream and a third video stream provided by an embodiment of the present disclosure;

FIG. 5 is a flowchart of another image rendering method provided by an embodiment of the present disclosure;

FIG. 6 is a schematic block diagram of an image rendering apparatus provided by an embodiment of the present disclosure; and

FIG. 7 is a schematic block diagram of an electronic device provided by an embodiment of the present disclosure.

### DETAILED DESCRIPTION

The technical solutions in the embodiments of the present disclosure will be described clearly and completely with reference to the drawings in the embodiments of the present disclosure. It is obvious that the described embodiments are only some embodiments of the present disclosure, but not all embodiments. All other embodiments obtained by those of ordinary skill in the art without paying any creative efforts according to the embodiments in the present disclosure shall fall within the protection scope of the present disclosure.

It should be noted that the terms “first” and “second” in the description, claims, and drawings of the present disclosure are used to distinguish similar objects, but do not necessarily represent a specific order or sequence. It should be understood that the data used in this way is interchangeable under appropriate circumstances, so that the embodiments of the present disclosure described herein can be implemented in an order other than those illustrated or described herein. In addition, the terms “include” and “have” and any variations thereof are intended to cover non-exclusive inclusion. For example, a process, method, system, product, or server that includes a series of steps or units is not necessarily limited to those steps or units that are clearly listed, but may include other steps or units that are not clearly listed or are inherent to these processes, methods, products, or devices.

In the embodiments of the present disclosure, words such as “exemplary” or “for example” are used to represent examples, illustrations, or descriptions. Any embodiment or solution described as/by “exemplary” or “for example” in the embodiments of the present disclosure should not be construed as being more preferred or advantageous than other embodiments or solutions. Rather, the use of words such as “exemplary” or “for example” is intended to present relevant concepts in a specific manner.

In the description of the embodiments of the present disclosure, unless otherwise specified, “a plurality of/multiple” means two or more, that is, at least two. “At least one” means one or more. “Arbitrary” means any one or any several.

In order to facilitate the understanding of the embodiments of the present disclosure, before the description of the various embodiments of the present disclosure, some concepts involved in all the embodiments of the present disclosure are first appropriately explained, as follows:
1) Virtual reality (Virtual Reality, VR), a technology for creating and experiencing a virtual world, that is, a computer-generated virtual environment, which is a multi-source information (the virtual reality mentioned in the present disclosure includes at least visual perception, and may further include auditory perception, tactile perception, kinesthetic perception, and even gustatory perception, olfactory perception, etc.), and realizes the simulation of fused, interactive three-dimensional dynamic visual scenery and entity behavior in the virtual environment, so that users are immersed in the simulated virtual reality environment, and the application in various virtual environments such as maps, games, videos, education, medical treatment, simulation, collaborative training, sales, assisted manufacturing, maintenance and repair, etc. is realized.
2) Virtual reality device (VR device), a terminal that realizes a virtual reality effect, which may usually be provided in the form of glasses, a head-mounted display (Head Mount Display, HMD), and contact lenses, for realizing visual perception and other forms of perception. Certainly, the form of the virtual reality device is not limited to this, and it may be further miniaturized or enlarged according to actual needs.

Optionally, the virtual reality devices described in the embodiments of the present disclosure may include but are not limited to the following types:
2.1) PC virtual reality (PCVR) device, which uses a PC to perform related calculations and data output of a virtual reality function, and an external PC virtual reality device uses the data output by the PC to achieve the effect of virtual reality.
2.2) Mobile virtual reality device, which supports setting a mobile terminal (such as a smart phone) in various ways (such as a head-mounted display provided with a dedicated card slot), and is connected to the mobile terminal in a wired or wireless manner, and the mobile terminal performs related calculations of a virtual reality function and outputs data to the mobile virtual reality device, for example, watching a virtual reality video through an APP of the mobile terminal.
2.3) All-in-one virtual reality device, which has a processor for performing related calculations of a virtual function, and thus has an independent virtual reality input and output function, and does not need to be connected to a PC or a mobile terminal, and has a high degree of freedom in use.
3) Augmented reality (Augmented Reality, AR): a technology of calculating camera posture parameters of a camera in the real world (or referred to as a three-dimensional world, the reality world) in real time in a process of image acquisition by the camera, and adding virtual elements to an image acquired by the camera according to the camera posture parameters. The virtual elements include but are not limited to images, videos, and three-dimensional models. The goal of the AR technology is to overlay the virtual world on the reality world on a screen for interaction.
4) Mixed reality (Mixed Reality, MR): a simulated setting that integrates computer-created sensory input (for example, virtual objects) with sensory input from a physical setting or a representation thereof. In some MR settings, the computer-created sensory input may be adapted to changes in the sensory input from the physical setting. In addition, some electronic systems for presenting the MR setting may monitor orientation and/or position relative to the physical setting, to enable the virtual objects to interact with real objects (that is, physical elements from the physical setting or representations thereof). For example, the system may monitor movement so that a virtual plant appears to be stationary relative to a physical building.
5) Extended reality (Extended Reality, XR) refers to all real and virtual combined environments and frame rate adjustments generated by computer technologies and wearable devices, which includes various forms such as virtual reality (VR), augmented reality (AR), and mixed reality (MR).
6) Virtual scene (also referred to as virtual space), a virtual scene displayed (or provided) when an application is running on an electronic device. The virtual scene may be an emulation environment of the reality world, a semi-emulation and semi-fictitious virtual scene, or a pure fictitious virtual scene. The virtual scene may be any of a two-dimensional virtual scene, a 2.5-dimensional virtual scene, or a three-dimensional virtual scene, and the dimension of the virtual scene is not limited in the embodiments of the present disclosure. For example, the virtual scene may include sky, land, ocean, etc., and the land may include environmental elements such as desert and city.
7) Virtual object (also referred to as virtual item), an object that interacts in the virtual scene, is controlled by a user or a robot program (for example, a robot program based on artificial intelligence), and is capable of being stationary, moving, and performing various behaviors in the virtual scene.

As described above, the XR device may provide the user with a wide variety of XR image contents. However, since XR images have high complexity, more rendering resources are required when XR images are rendered, resulting in relatively high rendering power consumption for XR images. This tends to cause stuttering in the display of XR images, and also shortens the standby time of XR devices.

In view of the above technical problem, the present disclosure provides an image rendering method and apparatus, a device, and a storage medium to solve the problem that when an XR image with relatively high complexity is rendered, the rendering power consumption is relatively significant, which causes stuttering in the display of the XR image and shortens the standby time of the XR device.

The technical solutions provided in the embodiments of the present disclosure are described in detail below through some embodiments. The embodiments described below may be combined with each other, and the same or similar concepts or processes may not be repeated in some embodiments.

FIG. 1 is a flowchart of an image rendering method provided by an embodiment of the present disclosure. The image rendering method of this embodiment of the present disclosure may be performed by an image rendering apparatus, which may be composed of hardware and/or software and may be integrated in an electronic device. In the present disclosure, the electronic device may optionally be any hardware device to which an XR technology is applied, such as an XR device, and the type of the electronic device is not limited here.

As shown in FIG. 1, the method may include the following steps.
S101, determining a gaze region of an image frame in an original video stream.

In the present disclosure, the original video stream refers to a to-be-displayed video stream provided by any XR application in the XR device to a user. For example, when the XR application is a live broadcast application, the to-be-displayed video stream may be a live video stream; when the XR application is a video playback application, the to-be-displayed video stream may be any type of video stream, such as a game video stream, and the to-be-displayed video stream is not specifically limited here.

The gaze region refers to a region where sight is concentrated when a person observes an object with eyes.

In some optional embodiments, the determining the gaze region of the image frame in the original video stream may include one of the following manners.

In a first manner, an eye tracking system in the XR device may be activated, so that an image acquisition device (a camera, an infrared sensor, or the like) in the eye tracking system is used to collect eye movement data of the user, and then the eye movement data of the user is analyzed to determine a gaze point position of the user. Then, a gaze region of the user on a screen is determined according to the gaze point position of the user, and the gaze region is determined as the gaze region of the image frame in the original video stream.

In a second manner, generally, the gaze point of the human eyes will be concentrated in a relatively small region. And the region may be within an angle of view of about 1 degree to 2 degrees. Therefore, in the present disclosure, a gaze region between 1 degree and 2 degrees may also be preset according to the gaze point region of the human eyes, and the gaze region is determined as the gaze region of the image frame in the original video stream.

It should be noted that, in the present disclosure, in addition to the above two manners, other manners may also be used to determine the gaze region of the image frame in the original video stream, which is not limited here.
S102, rendering the gaze region of the image frame by using a first frame rate to obtain a first video stream.
S103, rendering the image frame by using a second frame rate to obtain a second video stream, where the first frame rate is k times the second frame rate, and k is greater than or equal to 2.

The first frame rate may be consistent with a display refresh rate of the screen. For example, when the display refresh rate is 90 Hertz (Hz), the first frame rate may optionally be 90 Hz. Certainly, the first frame rate may also be inconsistent with the display refresh rate of the screen, but may be any frame rate that is k times the second frame rate, and the first frame rate is not specifically limited here.

The display refresh rate of the screen refers to the number of times the screen updates the display content per second.

The second frame rate may be any frame rate that is less than 1/k times the first frame rate, where k may optionally be a real number greater than or equal to 2. Specifically, k may optionally be any integer such as 2, 3, 4, or 5, or k may also optionally be any non-integer such as 2.5. That is, k may optionally be any integer or non-integer greater than or equal to 2. For example, when the first frame rate is 90 Hertz (Hz), the second frame rate may be 90/2=45 Hz, or may be 90/3=30 Hz, or may also be 90/4=22.5 Hz, etc.

In some optional embodiments, in the present disclosure, the gaze region of the image frame in the original video stream may be rendered by using the first frame rate to obtain the first video stream with the first frame rate. In addition, the full-view region of the image frame in the original video stream is rendered by using the second frame rate to obtain the second video stream with the second frame rate.

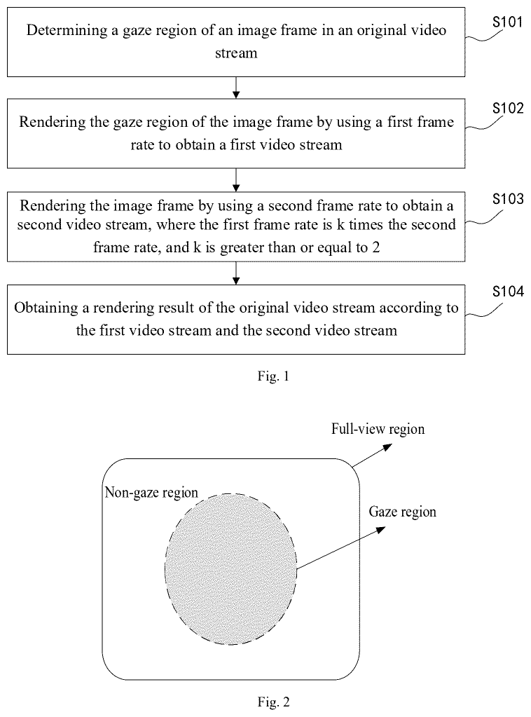

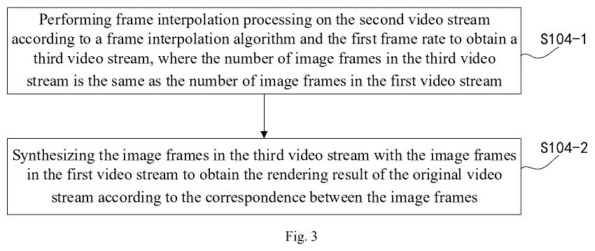

The above full-view region may be understood as a full-field region, that is, the full-view region may include a gaze region and a non-gaze region, as shown in FIG. 2. The non-gaze region is opposite to the gaze region, and is a region with relatively less sight when the human eyes observe the object.

Optionally, in the present disclosure, the rendering of the gaze region of the image frame in the original video stream and the rendering of the full-view region of the image frame in the original video stream may be implemented in one of the following manners.
Implementation manner 1: it may be implemented by two independent rendering threads, rendering processes, or rendering chips. Specifically, a first rendering thread, a first rendering process, or a first rendering chip is used to render the gaze region of the image frame in the original video stream by using the first frame rate to obtain the first video stream with the first frame rate; and a second rendering thread, a second rendering process, or a second rendering chip is used to render the full-view region of the image frame in the original video stream by using the second frame rate to obtain the second video stream with the second frame rate. Alternatively, the first rendering thread, the first rendering process, or the first rendering chip is used to render the full-view region of the image frame in the original video stream by using the second frame rate to obtain the second video stream with the second frame rate, and the second rendering thread, the second rendering process, or the second rendering chip is used to render the gaze region of the image frame in the original video stream by using the first frame rate to obtain the first video stream with the first frame rate.
Implementation manner 2: it may be implemented by one rendering thread, rendering process, or rendering chip. Specifically, the rendering thread, the rendering process, or the rendering chip is first used to render the gaze region of the image frame in the original video stream by using the first frame rate to obtain the first video stream with the first frame rate; and then the rendering thread, the rendering process, or the rendering chip continues to be used to render the full-view region of the image frame in the original video stream by using the second frame rate to obtain the second video stream with the second frame rate. Alternatively, the rendering thread, the rendering process, or the rendering chip may first be used to render the full-view region of the image frame in the original video stream by using the second frame rate to obtain the second video stream with the second frame rate; and then the rendering thread, the rendering process, or the rendering chip continues to be used to render the gaze region of the image frame in the original video stream by using the first frame rate to obtain the first video stream with the first frame rate.

It should be understood that the above rendering thread, rendering process, or rendering chip refers to one of a rendering thread, a rendering process, and a rendering chip, for example, it may be a rendering thread, or may be a rendering process, or may also be a rendering chip, which is not specifically limited in the present disclosure.

By way of example, assuming that the first frame rate is 90 Hz and the second frame rate is 45 Hz, when a rendering operation is performed on the image frame in the original video stream, on a first image frame of the original video stream, the gaze region of the first image frame is rendered at 90 Hz, and the full-view region of the first image frame is rendered at 45 Hz; then, when a second image frame of the original video stream is processed, since the first frame rate is twice the second frame rate, only the gaze region of the second image frame is rendered at 90 Hz, and the rendering of the full-view region of the second image frame at 45 Hz is not performed; the subsequent image frames in the original video stream are processed in the same way to obtain the first video stream and the second video stream.

That is, in the present disclosure, the gaze region of each image frame in the original video stream is rendered by using the first frame rate, and the full-view region of every k image frames in the original video stream is rendered by using the second frame rate. In this way, the data amount of image rendering may be reduced while ensuring high-quality rendering of the gaze region in the image frame, thereby relieving the rendering load and reducing the rendering power consumption.
S104, obtaining a rendering result of the original video stream according to the first video stream and the second video stream.

Considering that the first frame rate is k times the second frame rate, that is, the number of image frames in the second video stream is less than the number of image frames in the first video stream. When the rendering result of the original video stream is obtained according to the first video stream and the second video stream, first, frame interpolation processing may be performed on the image frames in the second video stream according to the first frame rate, so that the number of image frames in the second video stream after the frame interpolation processing is the same as the number of image frames in the first video stream. Then, the first video stream and the processed second video stream are synthesized according to the image frames at the same positions to obtain a target video stream, and the target video stream is determined as the rendering result of the original video stream. Then, based on the rendering result, the image is displayed on a screen.

For example, assuming that the first frame rate corresponding to the first video stream is 90 Hz and the second frame rate corresponding to the second video stream is 45 Hz, when there are 20 image frames in the first video stream, which are image frame 1, image frame 2, . . . , and image frame 20, there are 10 image frames in the second video stream, which are image frame 1, image frame 3, image frame 5, image frame 7, image frame 9, image frame 11, image frame 13, image frame 15, image frame 17, and image frame 19. At this time, the frame interpolation processing may be performed on the image frames in the second video stream according to the first frame rate of 90 Hz to obtain a processed second video stream with the same number of image frames as in the first video stream, specifically, image frame 1, image frame 2, image frame 3, image frame 4, . . . , and image frame 20. Then, the image frames in the first video stream and the image frames in the processed second video stream are synthesized according to the image frames at the same positions to obtain the target video stream. In the processed second video stream, the image frame 2 is a predicted image frame generated on the basis of the image frame 1, the image frame 4 is a predicted image frame generated on the basis of the image frame 3, and so on. That is, the image frames inserted in the processed second video stream are all predicted and generated from the known image frame at the previous position.

It may be understood that, in the present disclosure, by rendering the gaze region and the full-view region of the image frame in the original video stream by using different frame rates (that is, the first frame rate and the second frame rate), it may be ensured that the gaze region in the image frame is rendered at a relatively high frame rate, and at the same time, the full-view region in the image frame is rendered at a relatively low frame rate, which may reduce the data amount of rendering of the image frame of the full-view region, reduce the rendering power consumption, and at the same time ensure the rendering quality of the gaze region of the image frame.

According to the technical solution disclosed in the embodiments of the present disclosure, a gaze region of an image frame in an original video stream is determined, then the gaze region of the image frame is rendered by using a first frame rate to obtain a first video stream, and the image frame is rendered by using a second frame rate to obtain a second video stream, where the first frame rate is k times the second frame rate, and k is greater than or equal to 2, and then a rendering result of the original video stream is obtained according to the first video stream and the second video stream. In this way, by rendering the gaze region and the full-view region of the image frame in the video stream by using different frame rates, the data amount of image rendering may be reduced, and the rendering load may be reduced, thereby reducing the rendering power consumption for XR images, improving the display smoothness of the XR images, and extending the standby time of XR devices.

On the basis of the foregoing embodiments, it is considered that the XR device guides the user to generate an experience of being in a virtual space according to information difference obtained by human left and right eyes. Specifically, the XR device may directly project images onto eyes of the user through a screen, where the left and right eyes respectively correspond to an independent display screen, so that images of the left and right eyes are respectively displayed through the display screen corresponding to the left eye and the display screen corresponding to the right eye. There is a very slight difference between the images of the left and right eyes.

Therefore, in the present disclosure, the original video stream may include a first original video stream corresponding to the left eye and a second original video stream corresponding to the right eye, where the first original video stream and the second original video stream have different viewing angles.

In such case, when a rendering operation is performed on the image frames in the first original video stream and the second original video stream, in the present disclosure, optionally, the gaze region of the image frame in the first original video stream is rendered by using the first frame rate to obtain a first gaze point rendering image stream; the gaze region of the image frame in the second original video stream is rendered by using the first frame rate to obtain a second gaze point rendering image stream; and the full-view region of the image frame in the first original video stream is rendered by using the second frame rate, or the full-view region of the image frame in the second original video stream is rendered by using the second frame rate to obtain a full-view rendering image stream. Then, a target video stream corresponding to the left eye is obtained according to the first gaze point rendering image stream and the full-view rendering image stream, and a target video stream corresponding to the right eye is obtained according to the second gaze point rendering image stream and the full-view rendering image stream.

That is, in the present disclosure, for one of the original video streams corresponding to the left and right eyes of the user, the image frame thereof may be rendered by using the second frame rate, so that the left and right eyes share one full-view rendering image stream with the second frame rate, which may avoid rendering one full-view rendering image stream for each eye of the user, thereby further reducing the rendering workload and reducing the rendering power consumption of the XR image.

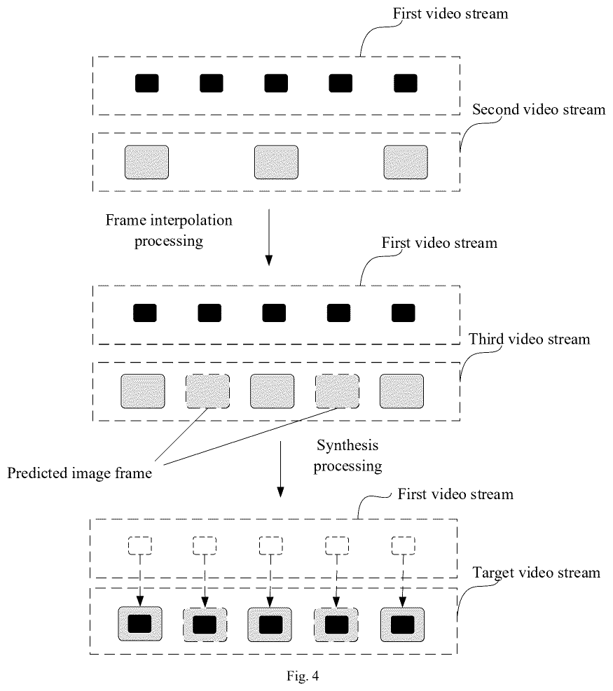

Step S104 in the foregoing embodiments is further explained below with reference to FIG. 3. As shown in FIG. 3, step S104 may include the following steps S104-1 to S104-2.
S104-1, performing frame interpolation processing on the second video stream according to a frame interpolation algorithm and the first frame rate to obtain a third video stream, where the number of image frames in the third video stream is the same as the number of image frames in the first video stream.

The above frame interpolation algorithm may include, but is not limited to, an Asynchronous Timewarp (ATW) algorithm, an Asynchronous Spacewarp (ASW) algorithm, a Programmed Time Warping (PTW) algorithm, and the like.

In some optional embodiments, since the first frame rate is k times the second frame rate, that is, the second video stream is obtained by performing the rendering operation once for every k image frames in the original video stream, the number of image frames in the second video stream is less than the number of image frames in the first video stream.

Then, in order to obtain the rendering result of the original video stream according to the first video stream and the second video stream, in the present disclosure, the frame interpolation processing may be performed on the second video stream according to one of the above multiple frame interpolation algorithms and the first frame rate of the first video stream to obtain the third video stream with the same number of image frames as in the first video stream.
S104-2, synthesizing the image frames in the third video stream with the image frames in the first video stream according to the correspondence between the image frames in the first video stream and the image frames in the third video stream to obtain the rendering result of the original video stream.

After the third video stream with the same number of image frames as in the first video stream is obtained, in the present disclosure, the rendering result of the original video stream may be obtained according to the third video stream and the first video stream.

In some optional embodiments, first, the correspondence between the image frames in the first video stream and the image frames in the third video stream in the first video stream and the image frames in the third video stream may be determined. Then, the image frames in the third video stream and the image frames in the first video stream are synthesized according to the correspondence between the image frames in the first video stream and the image frames in the third video stream to obtain the rendering result of the original video stream.

Optionally, the above determining the correspondence between the image frames in the first video stream and the image frames in the third video stream may include one of the following cases.
Case 1, determining the correspondence between the image frames in the first video stream and the image frames in the third video stream according to timestamps of the image frames in the first video stream and timestamps of the image frames in the third video stream.

Considering that when the number of image frames in the first video stream is the same as the number of image frames in the third video stream, the timestamp corresponding to each image frame in the first video stream and the timestamp corresponding to each image frame in the third video stream should also be the same. Therefore, in the present disclosure, the image frames with the same timestamp may be determined from the first video stream and the third video stream according to the timestamps of the image frames, and two image frames with the same timestamp are determined as having a correspondence.

For example, assuming that the number of image frames in the first video stream and the number of image frames in the third video stream are both 3, two image frames corresponding to each timestamp are determined respectively from the first video stream and the third video stream, specifically, image frame X1 and image frame Y1 corresponding to a first timestamp, image frame X2 and image frame Y2 corresponding to a second timestamp, and image frame X3 and image frame Y3 corresponding to a third timestamp. At this time, it may be determined that there is a correspondence between image frame X1 and image frame Y1, there is a correspondence between image frame X2 and image frame Y2, and there is a correspondence between image frame X3 and image frame Y3.
Case 2, determining the correspondence between the image frames in the first video stream and the image frames in the third video stream according to frame identifications of the image frames in the first video stream and frame identifications of the image frames in the third video stream.

The frame identification may be understood as identity information that may uniquely determine an image frame, such as an image frame sequence number, an image frame position, or an image frame name, which is not limited here.

For example, assuming that the number of image frames in the first video stream and the number of image frames in the third video stream are both 3, the frame identifications of each of the image frames are respectively acquired from the first video stream and the third video stream. When the frame identifications of the three image frames in the first video stream are image frame X11, image frame X12, and image frame X13, respectively, and when the frame identifications of the three image frames in the third video stream are image frame X21, image frame X22, and image frame X23, respectively, it may be determined that image frame X11 and image frame X21 have the same frame sequence number, image frame X12 and image frame X22 have the same frame sequence number, and image frame X13 and image frame X23 have the same frame sequence number. At this time, it may be determined that there is a correspondence between image frame X11 and image frame X21, there is a correspondence between image frame X12 and image frame X22, and there is a correspondence between image frame X13 and image frame X23.
Case 3, determining the correspondence between the image frames in the first video stream and the image frames in the third video stream according to content similarity between the image frames in the first video stream and the image frames in the third video stream.

Considering that the content similarity between the image frames having a correspondence is relatively high, in the present disclosure, it is also possible to determine the content similarity between each image frame in the first video stream and each image frame in the third video stream, and then determine the two image frames with the highest similarity from the first video stream and the third video stream as having a correspondence.

Further, in the present disclosure, the image frames in the third video stream and the image frames in the first video stream are synthesized according to the correspondence between the image frames in the first video stream and the image frames in the third video stream to obtain the rendering result of the original video stream. Optionally, the gaze region of the image frame in the third video stream is determined according to the gaze region of the image frame in the first video stream. Then, the gaze region of the image frame in the third video stream is replaced with the gaze region of the image frame in the first video stream, and then the third video stream after replacement is determined as the rendering result of the original video stream, as shown in FIG. 4, for example.

That is, in the present disclosure, the image frame in the video stream with the second frame rate is used as the background region of the rendering result, and the image frame in the video stream with the first frame rate is used as the foreground region of the rendering result. In this way, most rendering resources may be concentrated on processing the gaze region with many picture details and concentrated sight of the user, and a small amount of rendering resources may be used to process the peripheral visual region with few picture details and outside the gaze region, which may greatly reduce the rendering workload, thereby reducing the rendering power consumption. Moreover, when the rendering power consumption is reduced, the heat generation of the hardware may be reduced, making the rendering system more stable, thereby indirectly improving the display smoothness of the XR image and extending the standby time of the XR device.

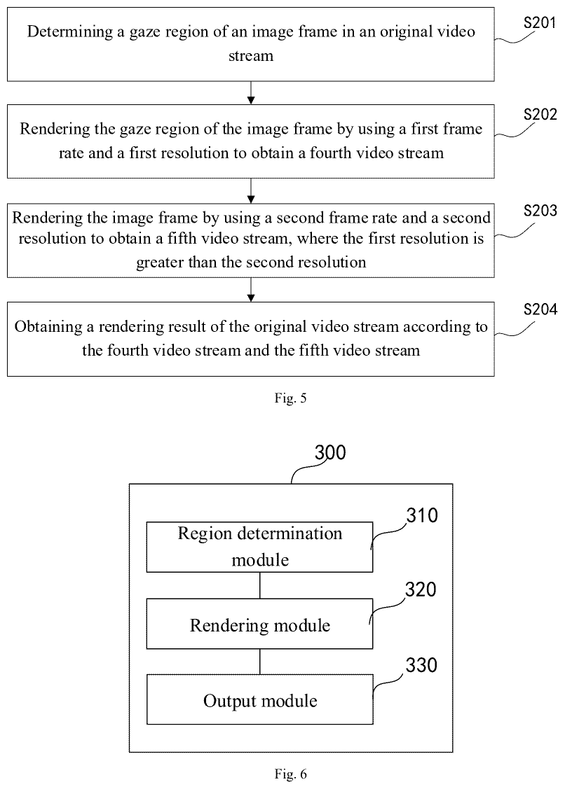

In some embodiments, it is considered that in the process of image rendering, the higher the resolution of the image frame, the more rendering resources will be consumed. Therefore, in the present disclosure, on the basis of rendering the gaze region and the full-view region of the image frame in the original video stream by using different frame rates, optionally, the gaze region and the full-view region of the image frame in the original video stream are rendered by using different resolutions, so that the data amount of rendering is reduced, thereby further reducing the rendering power consumption. With reference to FIG. 5 below, the rendering of the gaze region and the full-view region of the image frame in the original video stream by using different resolutions in the image rendering method provided by the present disclosure is specifically described.

As shown in FIG. 5, the method may include the following steps.
S201, determining a gaze region of an image frame in an original video stream.
S202, rendering the gaze region of the image frame by using a first frame rate and a first resolution to obtain a fourth video stream.
S203, rendering the image frame by using a second frame rate and a second resolution to obtain a fifth video stream, where the first resolution is greater than the second resolution.

It is considered that the higher the resolution, the higher the clarity and fineness of the image, that is, the better the image quality. In the present disclosure, while the gaze region of the image frame in the original video stream is rendered by using the first frame rate, the gaze region of the image frame in the original video stream is also rendered by using a relatively high first resolution. In addition, while the full-view region of the image frame in the original video stream is rendered by using the second frame rate, the full-view region of the image frame in the original video stream is also rendered by using a second resolution less than the first resolution. In this way, the gaze region and the full-view region of the image frame in the original video stream may be rendered by using different frame rates and different resolutions, which may reduce the data amount of rendering of the full-view region while ensuring high-definition and high-quality rendering of the gaze region, thereby further relieving the rendering load and reducing the rendering power consumption.
S204, obtaining a rendering result of the original video stream according to the fourth video stream and the fifth video stream.

Since the number of image frames in the fifth video stream is less than the number of image frames in the fourth video stream, in the present disclosure, the obtaining the rendering result of the original video stream according to the fourth video stream and the fifth video stream may include the following steps.
Step 1: performing frame interpolation processing on the fifth video stream according to a frame interpolation algorithm and the first frame rate to obtain a processed fifth video stream, where the number of image frames in the processed fifth video stream is the same as the number of image frames in the fourth video stream.
Step 2: synthesizing the image frames in the fourth video stream with the image frames in the processed fifth video stream according to the correspondence between the image frames in the first video stream and the image frames in the third video stream to obtain the rendering result of the original video stream.

It should be noted that the implementation principles of the above steps 1 and 2 are the same as or similar to the implementation principles of steps S104-1 and S104-2 in the foregoing embodiments, and the implementation process of the above steps 1 and 2 may refer to the implementation of steps S104-1 and S104-2 in the foregoing embodiments, which will not be repeated here.

According to the technical solution disclosed in the embodiments of the present disclosure, a gaze region of an image frame in an original video stream is determined, then the gaze region of the image frame is rendered by using a first frame rate to obtain a first video stream, and the image frame is rendered by using a second frame rate to obtain a second video stream, where the first frame rate is k times the second frame rate, and k is greater than or equal to 2, and then a rendering result of the original video stream is obtained according to the first video stream and the second video stream. In this way, by rendering the gaze region and the full-view region of the image frame in the video stream by using different frame rates, the data amount of image rendering may be reduced, and the rendering load may be reduced, thereby reducing the rendering power consumption for XR images, improving the display smoothness of the XR images, and extending the standby time of XR devices. In addition, in the present disclosure, while the gaze region and the full-view region of the image frame in the original video stream are rendered by using different frame rates, the gaze region and the full-view region of the image frame in the original video stream are also rendered by using different resolutions, so that the data amount of rendering may be further reduced, thereby further reducing the rendering power consumption, and providing conditions for further improving the display smoothness of the XR images and extending the standby time of the XR devices.

An image rendering apparatus provide by an embodiment of the present disclosure is described below with reference to FIG. 6. As shown in FIG. 6, the image rendering apparatus 300 includes: a region determination module 310, a rendering module 320, and an output module 330.

The region determination module 310 is configured to determine a gaze region of an image frame in an original video stream;
the rendering module 320 is configured to render the gaze region of the image frame by using a first frame rate to obtain a first video stream, and render the image frame by using a second frame rate to obtain a second video stream, where the first frame rate is k times the second frame rate, and k is greater than or equal to 2; and
the output module 330 is configured to obtain a rendering result of the original video stream according to the first video stream and the second video stream.

In an optional implementation of the embodiment of the present disclosure, the output module 330 includes:
a processing unit, configured to perform frame interpolation processing on the second video stream according to a frame interpolation algorithm and the first frame rate to obtain a third video stream, where the number of image frames in the third video stream is the same as the number of image frames in the first video stream; and
a synthesis unit, configured to synthesize the image frames in the third video stream with the image frames in the first video stream to obtain the rendering result of the original video stream according to the correspondence between the image frames in the first video stream and the image frames in the third video stream.

In an optional implementation of the embodiment of the present disclosure, the synthesis unit is further configured to:
replace the gaze region of the image frame in the third video stream with the gaze region of the image frame in the first video stream, and determine the processed third video stream as the rendering result of the original video stream.

In an optional implementation of the embodiment of the present disclosure, the synthesis unit is further configured to:
determine the correspondence between the image frames in the first video stream and the image frames in the third video stream according to timestamps of the image frames in the first video stream and timestamps of the image frames in the third video stream; or
determine the correspondence between the image frames in the first video stream and the image frames in the third video stream according to frame identifications of the image frames in the first video stream and frame identifications of the image frames in the third video stream; or
determine the correspondence between the image frames in the first video stream and the image frames in the third video stream according to content similarity between the image frames in the first video stream and the image frames in the third video stream.

In an optional implementation of the embodiment of the present disclosure,
the rendering module 320 is further configured to render the gaze region of the image frame by using the first frame rate and a first resolution to obtain a fourth video stream, and render the image frame by using the second frame rate and a second resolution to obtain a fifth video stream, where the first resolution is greater than the second resolution; and
the output module 330 is further configured to obtain the rendering result of the original video stream according to the fourth video stream and the fifth video stream.

In an optional implementation of the embodiment of the present disclosure, the original video stream includes a first original video stream corresponding to a left eye and a second original video stream corresponding to a right eye, where the first original video stream and the second original video stream have different viewing angles.

It should be understood that the apparatus embodiment may correspond to the foregoing method embodiment. For similar descriptions, reference may be made to the method embodiment. To avoid repetitions, details are not described herein again. Specifically, the apparatus 300 shown in FIG. 6 may perform the method embodiment corresponding to FIG. 1, and the foregoing and other operations and/or functions of the modules in the apparatus 300 are respectively intended to implement corresponding procedures of the methods in FIG. 1, which are not repeated herein for the sake of brevity.

The apparatus 300 of the embodiments of the present disclosure is described above with reference to the drawings from the perspective of functional modules. It should be understood that the functional modules may be implemented in the form of hardware, or may be implemented by instructions in the form of software, or may also be implemented by a combination of hardware and a software module. Specifically, the steps in the method embodiments of the first aspect in the embodiments of the present disclosure may be completed by an integrated logic circuit of the hardware in a processor and/or the instructions in the form of the software. The steps of the method of the first aspect disclosed in the embodiments of the present disclosure may be directly embodied to be completed by a hardware of a decoding processor or by a combination of hardware in the decoding processor and a software module. Optionally, the software module may be located in a mature storage medium in the art, such as a random-access memory, a flash memory, a read-only memory, a programmable read-only memory, an electrically erasable programmable memory, or a register. The storage medium is located in a memory, and the processor reads information in the memory and completes the steps in the foregoing method embodiments of the first aspect in combination with the hardware of the processor.

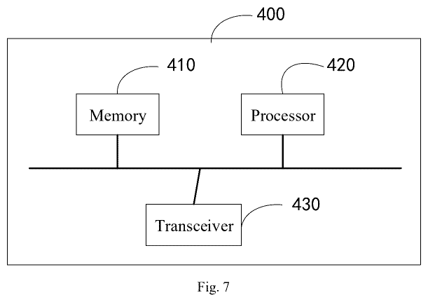

FIG. 7 is a schematic block diagram of an electronic device provided by an embodiment of the present disclosure. As shown in FIG. 7, the electronic device 400 may include: a memory 410 and a processor 420, where the memory 410 is configured to store a computer program and transmit the program codes to the processor 420. In other words, the processor 420 may invoke the computer program from the memory 410 and run the computer program to implement the image rendering method according to the first aspect in the embodiments of the present disclosure.

For example, the processor 420 may be configured to perform the above image rendering method according to instructions in the computer program.

In some optional embodiments, the above image rendering method includes:
determining a gaze region of an image frame in an original video stream;
rendering the gaze region of the image frame by using a first frame rate to obtain a first video stream;
rendering the image frame by using a second frame rate to obtain a second video stream, where the first frame rate is k times the second frame rate, and k is greater than or equal to 2; and
obtaining a rendering result of the original video stream according to the first video stream and the second video stream.

In some optional embodiments, the obtaining the rendering result of the original video stream according to the first video stream and the second video stream includes:
performing frame interpolation processing on the second video stream according to a frame interpolation algorithm and the first frame rate to obtain a third video stream, where the number of image frames in the third video stream is the same as the number of image frames in the first video stream; and
synthesizing the image frames in the third video stream with the image frames in the first video stream according to the correspondence between the image frames in the first video stream and the image frames in the third video stream to obtain the rendering result of the original video stream.

In some optional embodiments, the synthesizing the image frames in the third video stream with the image frames in the first video stream according to the correspondence between the image frames in the first video stream and the image frames in the third video stream to obtain the rendering result of the original video stream includes:
replacing the gaze region of the image frame in the third video stream with the gaze region of the image frame in the first video stream, and determining the third video stream after replacement as the rendering result of the original video stream.

In some optional embodiments, the method further includes:
determining the correspondence between the image frames in the first video stream and the image frames in the third video stream according to timestamps of the image frames in the first video stream and timestamps of the image frames in the third video stream; or
determining the correspondence between the image frames in the first video stream and the image frames in the third video stream according to frame identifications of the image frames in the first video stream and frame identifications of the image frames in the third video stream; or
determining the correspondence between the image frames in the first video stream and the image frames in the third video stream according to content similarity between the image frames in the first video stream and the image frames in the third video stream.

In some optional embodiments, the method further includes:
rendering the gaze region of the image frame by using the first frame rate and a first resolution to obtain a fourth video stream;
rendering the image frame by using the second frame rate and a second resolution to obtain a fifth video stream, where the first resolution is greater than the second resolution; and
obtaining the rendering result of the original video stream according to the fourth video stream and the fifth video stream.

In some optional embodiments, the original video stream includes a first original video stream corresponding to a left eye and a second original video stream corresponding to a right eye, where the first original video stream and the second original video stream have different viewing angles.

In some embodiments of the present disclosure, the processor 420 may include, but is not limited to:
a general-purpose processor, a Digital Signal Processor (DSP), an Application Specific Integrated Circuit (ASIC), a Field Programmable Gate Array (FPGA) or other programmable logic devices, a discrete gate or transistor logic device, a discrete hardware component, and the like.

In some embodiments of the present disclosure, the memory 410 includes, but is not limited to:
a volatile memory and/or a non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), which is used as an external cache. By way of exemplary but non-restrictive description, many forms of RAMs may be used, such as a Static RAM (SRAM), a Dynamic RAM (DRAM), a Synchronous DRAM (SDRAM), a Double Data Rate SDRAM (DDR SDRAM), an Enhanced SDRAM (ESDRAM), a synch link DRAM (SLDRAM), and a Direct Rambus RAM (DR RAM).

In some embodiments of the present disclosure, the computer program may be divided into one or more modules, and the one or more modules are stored in the memory 410 and executed by the processor 420 to complete the image rendering method provided by the present disclosure. The one or more modules may be a series of computer program instruction segments capable of completing specific functions, and the instruction segments are used to describe an execution process of the computer program in the electronic device.

As shown in FIG. 7, the electronic device 400 may further include:
a transceiver 430, which may be connected to the processor 420 or the memory 410.

The processor 420 may control the transceiver 430 to communicate with other devices, and specifically, the transceiver may send information or data to other devices, or receive information or data sent by other devices. The transceiver 430 may include a transmitter and a receiver. The transceiver 430 may further include an antenna, and there may be one or more antennas.

It should be understood that the components of the electronic device are connected to each other through a bus system. In addition to a data bus, the bus system further includes a power bus, a control bus, and a status signal bus.

The present disclosure further provides a computer storage medium having a computer program stored thereon, where the computer program, when executed by a computer, causes the computer to perform the image rendering method according to the first aspect described above.

In some optional embodiments, the above image rendering method includes:
determining a gaze region of an image frame in an original video stream;
rendering the gaze region of the image frame by using a first frame rate to obtain a first video stream;
rendering the image frame by using a second frame rate to obtain a second video stream, where the first frame rate is k times the second frame rate, and k is greater than or equal to 2; and
obtaining a rendering result of the original video stream according to the first video stream and the second video stream.

In some optional embodiments, the obtaining the rendering result of the original video stream according to the first video stream and the second video stream includes:
performing frame interpolation processing on the second video stream according to a frame interpolation algorithm and the first frame rate to obtain a third video stream, where the number of image frames in the third video stream is the same as the number of image frames in the first video stream; and
synthesizing the image frames in the third video stream with the image frames in the first video stream according to the correspondence between the image frames in the first video stream and the image frames in the third video stream to obtain the rendering result of the original video stream.

In some optional embodiments, the synthesizing the image frames in the third video stream with the image frames in the first video stream according to the correspondence between the image frames in the first video stream and the image frames in the third video stream to obtain the rendering result of the original video stream includes:
replacing the gaze region of the image frame in the third video stream with the gaze region of the image frame in the first video stream, and determining the third video stream after replacement as the rendering result of the original video stream.

In some optional embodiments, the method further includes:
determining the correspondence between the image frames in the first video stream and the image frames in the third video stream according to timestamps of the image frames in the first video stream and timestamps of the image frames in the third video stream; or
determining the correspondence between the image frames in the first video stream and the image frames in the third video stream according to frame identifications of the image frames in the first video stream and frame identifications of the image frames in the third video stream; or
determining the correspondence between the image frames in the first video stream and the image frames in the third video stream according to content similarity between the image frames in the first video stream and the image frames in the third video stream.

In some optional embodiments, the method further includes:
rendering the gaze region of the image frame by using the first frame rate and a first resolution to obtain a fourth video stream;
rendering the image frame by using the second frame rate and a second resolution to obtain a fifth video stream, where the first resolution is greater than the second resolution; and
obtaining the rendering result of the original video stream according to the fourth video stream and the fifth video stream.

In some optional embodiments, the original video stream includes a first original video stream corresponding to a left eye and a second original video stream corresponding to a right eye, where the first original video stream and the second original video stream have different viewing angles.

The present disclosure further provides a computer program product including program instructions, where the program instructions, when running on an electronic device, cause the electronic device to perform the image rendering method according to the first aspect described above.

In some optional embodiments, the above image rendering method includes:
determining a gaze region of an image frame in an original video stream;
rendering the gaze region of the image frame by using a first frame rate to obtain a first video stream;
rendering the image frame by using a second frame rate to obtain a second video stream, where the first frame rate is k times the second frame rate, and k is greater than or equal to 2; and
obtaining a rendering result of the original video stream according to the first video stream and the second video stream.

In some optional embodiments, the obtaining the rendering result of the original video stream according to the first video stream and the second video stream includes:
performing frame interpolation processing on the second video stream according to a frame interpolation algorithm and the first frame rate to obtain a third video stream, where the number of image frames in the third video stream is the same as the number of image frames in the first video stream; and
synthesizing the image frames in the third video stream with the image frames in the first video stream according to the correspondence between the image frames in the first video stream and the image frames in the third video stream to obtain the rendering result of the original video stream.

In some optional embodiments, the synthesizing the image frames in the third video stream with the image frames in the first video stream according to the correspondence between the image frames in the first video stream and the image frames in the third video stream to obtain the rendering result of the original video stream includes:
replacing the gaze region of the image frame in the third video stream with the gaze region of the image frame in the first video stream, and determining the third video stream after replacement as the rendering result of the original video stream.

In some optional embodiments, the method further includes:
determining the correspondence between the image frames in the first video stream and the image frames in the third video stream according to timestamps of the image frames in the first video stream and timestamps of the image frames in the third video stream; or
determining the correspondence between the image frames in the first video stream and the image frames in the third video stream according to frame identifications of the image frames in the first video stream and frame identifications of the image frames in the third video stream; or
determining the correspondence between the image frames in the first video stream and the image frames in the third video stream according to content similarity between the image frames in the first video stream and the image frames in the third video stream.

In some optional embodiments, the method further includes:
rendering the gaze region of the image frame by using the first frame rate and a first resolution to obtain a fourth video stream;
rendering the image frame by using the second frame rate and a second resolution to obtain a fifth video stream, where the first resolution is greater than the second resolution; and
obtaining the rendering result of the original video stream according to the fourth video stream and the fifth video stream.

In some optional embodiments, the original video stream includes a first original video stream corresponding to a left eye and a second original video stream corresponding to a right eye, where the first original video stream and the second original video stream have different viewing angles.

When implemented in software, all or some of the embodiments may be implemented in the form of the computer program product. The computer program product includes one or more computer instructions. When the computer program instructions are loaded and executed on a computer, all or some of the processes or functions according to the embodiments of the present disclosure are generated. The computer may be a general-purpose computer, a dedicated computer, a computer network, or other programmable apparatuses. The computer instructions may be stored in the computer-readable storage medium, or may be transmitted from one computer-readable storage medium to another computer-readable storage medium. For example, the computer instructions may be transmitted from one website, computer, server or data center to another website, computer, server or data center in a wired (for example, a coaxial cable, an optical fiber, or a digital subscriber line (DSL)) or wireless (for example, infrared, wireless, or microwave) manner. The computer-readable storage medium may be any usable medium accessible by a computer, or a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid-state disk (SSD)), or the like.

Those of ordinary skill in the art may be aware that the modules and algorithm steps of various examples described in conjunction with the embodiments disclosed herein may be implemented in electronic hardware or a combination of computer software and electronic hardware. Whether these functions are performed in hardware or software depends on the specific application and design constraints of the technical solution. A person skilled in the art may implement the described functions by using different methods for each particular application, but such implementation should not be considered as going beyond the scope of the present disclosure.

In the several embodiments provided by the present disclosure, it should be understood that the disclosed system, apparatus, and method may be implemented in other manners. For example, the apparatus embodiment described above is merely an example. For example, the module division is merely logical function division and may be other division during actual implementation. For example, a plurality of modules or components may be combined or integrated into another system, or some features may be ignored or not implemented. In addition, other items shown or discussed as coupled, directly coupled, or communicating with each other may be indirectly coupled or communicating through some interface, apparatus, or device whether electrically, mechanically, or otherwise.

The modules described as separate parts may or may not be physically separate, and parts displayed as modules may or may not be physical modules, and may be located at one position, or may be distributed on a plurality of network units. Some or all of the modules may be selected according to actual needs to achieve the objectives of the solutions of the embodiments. For example, the functional modules in the embodiments of the present disclosure may be integrated into one processing module, each of the modules may exist alone physically, or two or more modules may be integrated into one module.

In the embodiments of the present disclosure, the term “module” or “unit” refers to a computer program or a part of a computer program with a predetermined function, and works with other related parts to achieve a predetermined goal, and may be implemented in whole or in part by using software, hardware (such as a processing circuit or a memory), or a combination thereof. Similarly, one processor (or a plurality of processors or memories) may be used to implement one or more modules or units. In addition, each module or unit may be a part of an overall module or unit that includes functions of the module or unit.

The above description is only specific implementations of the present disclosure, but is not intended to limit the scope of protection of the present disclosure. Any variation or replacement readily figured out by a person skilled in the art within the technical scope disclosed in the present disclosure shall fall within the scope of protection of the present disclosure. Therefore, the scope of protection of the present disclosure shall be subject to the scope of protection of the claims.

1. An image rendering method, comprising:
determining a gaze region of an image frame in an original video stream;
rendering the gaze region of the image frame by using a first frame rate to obtain a first video stream;
rendering the image frame by using a second frame rate to obtain a second video stream, wherein the first frame rate is k times the second frame rate, and k is greater than or equal to 2; and
obtaining a rendering result of the original video stream according to the first video stream and the second video stream.

2. The method of claim 1, wherein the obtaining a rendering result of the original video stream according to the first video stream and the second video stream comprises:
performing frame interpolation processing on the second video stream according to a frame interpolation algorithm and the first frame rate to obtain a third video stream, wherein a number of image frames in the third video stream is as same as a number of image frames in the first video stream; and
synthesizing the image frames in the third video stream with the image frames in the first video stream according to a correspondence between the image frames in the first video stream and the image frames in the third video stream to obtain the rendering result of the original video stream.

3. The method of claim 2, wherein the synthesizing the image frames in the third video stream with the image frames in the first video stream according to a correspondence between the image frames in the first video stream and the image frames in the third video stream to obtain the rendering result of the original video stream comprises:
replacing a gaze region of an image frame in the third video stream with a gaze region of an image frame in the first video stream, and determining the third video stream after replacement as the rendering result of the original video stream.

4. The method of claim 2, further comprising:
determining the correspondence between the image frames in the first video stream and the image frames in the third video stream according to timestamps of the image frames in the first video stream and timestamps of image frames in the third video stream; or
determining the correspondence between the image frames in the first video stream and the image frames in the third video stream according to frame identifications of the image frames in the first video stream and frame identifications of the image frames in the third video stream; or
determining the correspondence between the image frames in the first video stream and the image frames in the third video stream according to content similarity between the image frames in the first video stream and the image frames in the third video stream.

5. The method of claim 1, further comprising:
rendering the gaze region of the image frame by using the first frame rate and a first resolution to obtain a fourth video stream;
rendering the image frame by using the second frame rate and a second resolution to obtain a fifth video stream, wherein the first resolution is greater than the second resolution; and
obtaining the rendering result of the original video stream according to the fourth video stream and the fifth video stream.

6. The method of claim 1, wherein the original video stream comprises a first original video stream corresponding to a left eye and a second original video stream corresponding to a right eye, wherein the first original video stream and the second original video stream have different viewing angles.

7. An electronic device, comprising:
at least one processor and a memory, wherein the memory is configured to store a computer program, and the at least one processor is configured to invoke and run the computer program stored in the memory to perform an image rendering method, comprising:
determining a gaze region of an image frame in an original video stream;
rendering the gaze region of the image frame by using a first frame rate to obtain a first video stream;
rendering the image frame by using a second frame rate to obtain a second video stream, wherein the first frame rate is k times the second frame rate, and k is greater than or equal to 2; and
obtaining a rendering result of the original video stream according to the first video stream and the second video stream.

8. The electronic device of claim 7, wherein the obtaining a rendering result of the original video stream according to the first video stream and the second video stream comprises:
performing frame interpolation processing on the second video stream according to a frame interpolation algorithm and the first frame rate to obtain a third video stream, wherein a number of image frames in the third video stream is as same as a number of image frames in the first video stream; and
synthesizing the image frames in the third video stream with the image frames in the first video stream according to a correspondence between the image frames in the first video stream and the image frames in the third video stream to obtain the rendering result of the original video stream.

9. The electronic device of claim 8, wherein the synthesizing the image frames in the third video stream with the image frames in the first video stream according to a correspondence between the image frames in the first video stream and the image frames in the third video stream to obtain the rendering result of the original video stream comprises:
replacing a gaze region of an image frame in the third video stream with a gaze region of an image frame in the first video stream, and determining the third video stream after replacement as the rendering result of the original video stream.

10. The electronic device of claim 8, wherein the image rendering method further comprises:
determining the correspondence between the image frames in the first video stream and the image frames in the third video stream according to timestamps of the image frames in the first video stream and timestamps of image frames in the third video stream; or
determining the correspondence between the image frames in the first video stream and the image frames in the third video stream according to frame identifications of the image frames in the first video stream and frame identifications of the image frames in the third video stream; or
determining the correspondence between the image frames in the first video stream and the image frames in the third video stream according to content similarity between the image frames in the first video stream and the image frames in the third video stream.

11. The electronic device of claim 7, wherein the image rendering method further comprises:
rendering the gaze region of the image frame by using the first frame rate and a first resolution to obtain a fourth video stream;
rendering the image frame by using the second frame rate and a second resolution to obtain a fifth video stream, wherein the first resolution is greater than the second resolution; and
obtaining the rendering result of the original video stream according to the fourth video stream and the fifth video stream.

12. The electronic device of claim 7, wherein the original video stream comprises a first original video stream corresponding to a left eye and a second original video stream corresponding to a right eye, wherein the first original video stream and the second original video stream have different viewing angles.

13. A non-transient computer-readable storage medium for storing a computer program, wherein the computer program is configured to cause a computer to perform an image rendering method, comprising:
determining a gaze region of an image frame in an original video stream;
rendering the gaze region of the image frame by using a first frame rate to obtain a first video stream;
rendering the image frame by using a second frame rate to obtain a second video stream, wherein the first frame rate is k times the second frame rate, and k is greater than or equal to 2; and
obtaining a rendering result of the original video stream according to the first video stream and the second video stream.

14. The storage medium of claim 13, wherein the obtaining a rendering result of the original video stream according to the first video stream and the second video stream comprises:
performing frame interpolation processing on the second video stream according to a frame interpolation algorithm and the first frame rate to obtain a third video stream, wherein a number of image frames in the third video stream is as same as a number of image frames in the first video stream; and
synthesizing the image frames in the third video stream with the image frames in the first video stream according to a correspondence between the image frames in the first video stream and the image frames in the third video stream to obtain the rendering result of the original video stream.

15. The storage medium of claim 14, wherein the synthesizing the image frames in the third video stream with the image frames in the first video stream according to a correspondence between the image frames in the first video stream and the image frames in the third video stream to obtain the rendering result of the original video stream comprises:
replacing a gaze region of an image frame in the third video stream with a gaze region of an image frame in the first video stream, and determining the third video stream after replacement as the rendering result of the original video stream.

16. The storage medium of claim 14, wherein the image rendering method further comprises:
determining the correspondence between the image frames in the first video stream and the image frames in the third video stream according to timestamps of the image frames in the first video stream and timestamps of image frames in the third video stream; or
determining the correspondence between the image frames in the first video stream and the image frames in the third video stream according to frame identifications of the image frames in the first video stream and frame identifications of the image frames in the third video stream; or
determining the correspondence between the image frames in the first video stream and the image frames in the third video stream according to content similarity between the image frames in the first video stream and the image frames in the third video stream.

17. The storage medium of claim 13, wherein the image rendering method further comprises:
rendering the gaze region of the image frame by using the first frame rate and a first resolution to obtain a fourth video stream;
rendering the image frame by using the second frame rate and a second resolution to obtain a fifth video stream, wherein the first resolution is greater than the second resolution; and
obtaining the rendering result of the original video stream according to the fourth video stream and the fifth video stream.

18. The storage medium of claim 13, wherein the original video stream comprises a first original video stream corresponding to a left eye and a second original video stream corresponding to a right eye, wherein the first original video stream and the second original video stream have different viewing angles.
